(19) United States
(12) Patent Application Publication
(10) Pub. No.: US 2005/0238208 A1
(43) Pub. Date: Oct. 27, 2005

(54) Handheld biometric computer for 2D/3D image capture

(76) Inventor: Michael L. Sim, Reston, VA (US)

Correspondence Address: SCHIFF HARDIN, LLP;PATENT DEPARTMENT, 6600 SEARS TOWER, CHICAGO, IL, 60606-6473, US

(21) Appl. No.: 11/100,167

(22) Filed: Apr. 6, 2005

Related U.S. Application Data
(60) Provisional application No. 60/559,883, filed on Apr. 6, 2004.

(51) Int. Cl. G06K 9/00

(52) U.S. Cl. 382/115

(57) ABSTRACT

A method and apparatus for authenticating an identification of a person includes a portable computing device having a pair of imaging devices directed to a common location so as to generate a stereographic image of a subject. The portable computing device includes software for processing the image data to generate two dimensional and three dimensional biometric data of a person to be identified. The device is used to generate the biometric data for an identified person and then may be used to authenticate the identity of the person through comparison of newly acquired biometric data from the person to be identified to the previously acquired biometric data of the identified person.

### CROSS-REFERENCE TO RELATED APPLICATION

The present application claims the benefit of Provisional Patent Application Ser. No. 60/559,883, filed Apr. 6, 2004, which is incorporated herein by reference.

### BACKGROUND OF THE INVENTION

1. Field of the Invention

The present invention relates generally to a method and apparatus for identification of a person and in particular to a method and apparatus for authenticating an identification.

2. Description of the Related Art

Biometrics is the science of automatically identifying individuals based on their unique physiological and behavioral characteristics. Biometric information may be based on unique characteristics of a person's face, iris, voice, fingerprint, signature or DNA. These identification techniques can all be used to authenticate a person's identity from information stored in a database of held on a token in two dimensional barcode, magnetic stripe, smart card, USB (Universal Serial Bus) device, memory stick or RFID (Radio Frequency Identification) format device.

The use of facial recognition has advantages over and above those of other biometrics, particularly in that the process is non-intrusive. Until recently this process was limited to the person being in front of a camera connected to a PC. The advent of handheld wireless technology now allows us to migrate the recognition process to remote or difficult places where these devices can be connected via WLAN (Wireless Local Area Network), GPRS, Blue Tooth or CDMA (Code Division Multiple Access) for real time identification or authentication.

Identification systems are disclosed in International Patent Application publications WO 00/62474 published Oct. 19, 2000, and WO 02/09024 A1 published on Jan. 31, 2002. In WO 00/62474, a computer uses a facial biometric template to encode a document. In WO 02/09024 A1, a facial identification matrix is obtained. 2D and 3D biometric templates are created from a single camera and the facial index data is extracted. These published applications are incorporated herein by reference.

### SUMMARY OF THE INVENTION

The present invention provides a method and apparatus using a combination of two dimensional and three dimensional biometric template data to authenticate an identification. In particular, a device has a housing and two imaging devices mounted therein to generate stereographic images of a subject. The stereographic image of an identified person is obtained and two dimensional and three dimensional biometric data is generated therefrom. A person to be identified is imaged with the two imaging devices and new two dimensional and three dimensional biometric data is generated for the person to be identified. This is compared to the data of the identified person to determine if an identification is authenticated.

### BRIEF DESCRIPTION OF THE DRAWINGS

FIG. 1 is a schematic front view of a portable identification device having a fingerprint sensor;

FIG. 2 is a schematic review view of the portable identification device of FIG. 1 having dual imaging devices;

FIG. 3 is a top plan view of the portable identification device according to the preferred embodiment of the invention; and

FIG. 4 is a functional block diagram of hardware and software definition for the present invention.

### DETAILED DESCRIPTION OF THE PREFERRED EMBODIMENTS

In FIG. 1 is shown schematically an identification module 10 having a rugged housing and a touch pad fingerprint sensor 12. The fingerprint sensor 12 is used to obtain fingerprint biometric data.

In FIG. 2, the other end of the identification module 10 is shown. The module has two camera lenses 14 and imaging devices facing the same direction and spaced apart by a predetermined distance. The imaging devices are electronic imaging devices, such as CCD or CMOS imaging devices. Other types of imaging chips may be provided as well. Both imaging devices are operated at the same time to take two images spaced by the predetermined distance. Thus, the imaging devices obtain a stereographic image that includes three dimensional information of the object being imaged.

Proper illumination is important during imaging using the electronic imaging system. The illumination is provided here by a ring shaped lighting system 16 surrounding each lens. The ring shaped lighting system 16 of a preferred embodiment has a plurality of LEDs in each ring. The LEDs are of two types. First, five visible light LEDs 18 are provided in the ring light system and, second, five IR (InfraRed) LEDs 20 are provided in each ring light system. Thus, each ring light system includes ten LEDs to provide illumination to the subject being imaged. To ensure that the infrared energy from the IR LEDs is effective in illuminating the subject, the imaging chip (either CCD or CMOS) does not have an IR filter. Such IR filters are common in commercial imaging systems, such as digital cameras and will not be provided here. The lighting system can use either the visible light, the infrared light or both in obtaining the stereographic images.

The stereographic images are input to software to generate two dimensional and three dimensional biometric information about a subject. The biometric information is combined. This information is stored on a data carrier that is provided to a person that has been identified. The data carrier is any of a variety of data carriers, which are referred to as a token, card, or the like.

Images of the person are obtained using a wirelessly-enabled ruggedly built handheld computer equipped with twin image capture devices. These capture devices have the following capabilities: a) Single 2D image capture in IR or standard image format, b) 3D image capture in IR or standard image format, c) Two dimensional barcode reading, d) Embedded fingerprint scanner, e) IR light source, f) Standard LED illumination

Control of either the 2D or 3D image will be achieved utilizing software switches incorporated into the main application running on the handheld computer.

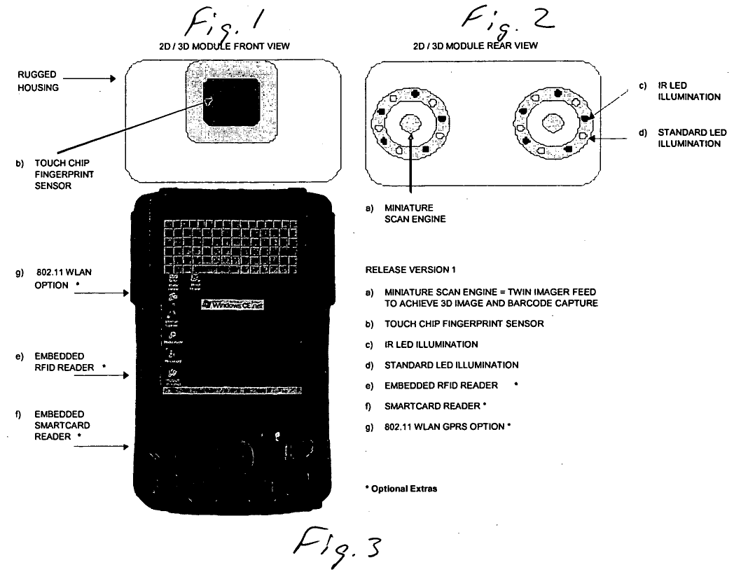

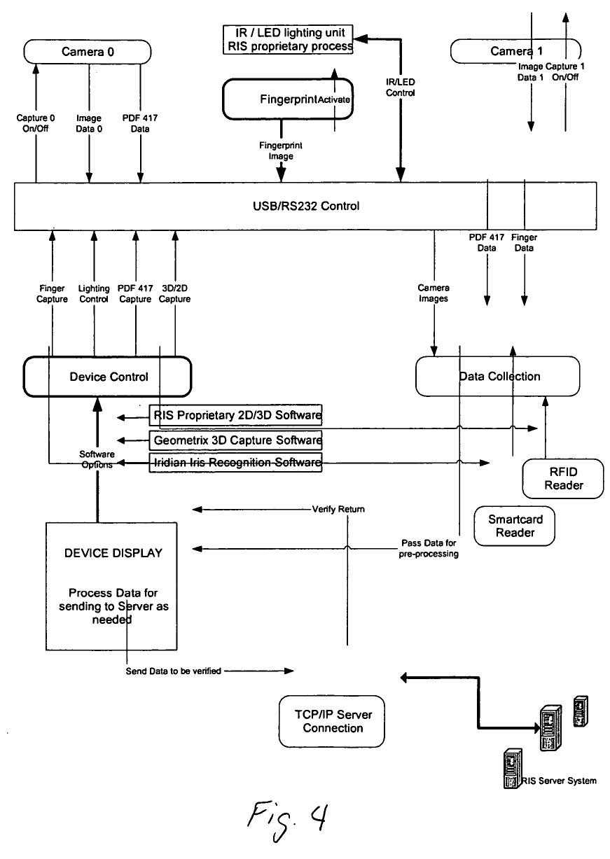

A 2D (two dimensional) image capture proceeds as follows. The module allows separate image capture via each image device. The first imaging optic is illuminated with the IR LEDs that surround both cameras (see FIG. 3). The IR image is used for the biometric enrollment and biometric authentication of the cardholder. The second image device is illuminated with the standard LED light source. The image captured with this optical device is used for storage and eventual visual authentication. It can be stored in either the token or held on a central server that is preferably accessed wirelessly. This image can be displayed either on the remote PC or on the handheld computer at the time of authentication.

This results in the software system capturing 2D facial images of the subject with improved image capture utilizing modified lighting and filtering methods.

FIG. 4 illustrates the software and hardware components for the present system and method, including their relations to one another.

The present invention has many uses in a variety of fields. Uses of the authentication process include travel documents (Visas/boarding passes), banking, healthcare, social security, immigration, education, prisons, law enforcement, secure access, ATM (Automatic Teller Machine), document security, voting and retail.

The 2D/3D image capture process proceeds as follows. First, the 3D image capture is described. The image capture devices are embedded into an attached module. The devices are set at a precise angle to one another so that both images come together at a combined focal point. The input from both capture devices are fed simultaneously via a 802.11b WLAN communication link to a central server. Software operating on the server stitches the two images together producing a 3D image. At this time the software extracts a 3D biometric template for comparison with the previously stored template. This 3D image capture and biometric conversion can occur with either IR or standard LED lighting.

Alternately, the 3D process is performed onboard the handheld computer when it is being operated under MS Windows CE.net or MS Windows Mobile, for example (see FIG. 3).

Thus, the present invention provides a method in which either single or twin imaging optics can with embedded IR and LED achieve both 2D and 3D facial biometric identification throughout the lighting variations encountered in the a day and at each location where the portable device may be used. A single 2D image capture in IR or standard image format may be provided. A 3D image capture in IR or standard image format may be provided.

The device is capable of capturing either 2D or 3D facial images with the different function controlled by software. This configuration will be housed in a ruggedly constructed clip-on device attached to a similar ruggedly built handheld computer or built into a single handheld computer with all the elements fully embedded.

Facial biometrics includes more than just surface features of the face. It includes iris, wrinkling, scarring, wounds, tattoo (and tattoo removal) patterns and features including sub-dermatological patterns, pores and other dermatological depth and variation, hair features such as thickness, baldness patterns as well as hair chemical composition, ears, teeth cavity and tooth growth patterns/dentures/gums and other features internal to the face including the mouth, nose and eyes, ears external and internal to the body, coloring, cranial and bone structure and pattern, internal anatomy, brain features, brain activity, pheromone (i.e., various odors of the person or object), salinity and chemical patterns, body temperature, motion patterns such as a specific tick or Parkinson's type shake, walking limp, nervous habit (such as scratching, tapping, knee-shaking), aura-type variations, and other features and characteristics. All of these features and characteristics can be detected and captured non-invasively as well. These are all included within the scope of the invention.

With the foregoing in mind, the identification and authentication method and system includes linked databases that might separately contain information on any one, or more than one, such feature named above. For example, the mobile device can include identification and authentication of bar coded or other stored information in more than one database. These multiple databases might include iris identification in one database and other facial identification in a second, third or more databases.

Various databases are in existence today and more are coming on-line that will have pieces of this type of biometric information—hospital records might have a cranial and brain scan MRI, dental records might have a full jaw, iris may be captured by an “agency” information database, states have pictures on licensing databases, etc. The present invention is capable of linking to and utilizing more than one database in the detection and authentication method and system.

The present system and method is designed not only to operate in normal (e.g., daylight, laboratory, good weather condition at sea level, at one atmosphere, etc) conditions. The system is mobile so that it will be utilized in a wide range of environments. These include space programs, subterranean, underwater, sea water/fresh water/brine water, excessive heat and cold, and under compromised or chemical/radiological environments including bio hazardous environments that present imperfect conditions. As such, the ruggedly built housing and the components are selected and constructed to withstand these harsh environmental conditions and so permit operation of the device wherever needed.

Not only is the system and method designed to be able to identify and authenticate in these environments as noted above, but also the method or system is designed so that it can function completely within its own ruggedized housing or enclosure. For example, a normal PDA or blackberry or the like will not function as intended in extreme environments noted above. The present device, by contrast, includes a system or method that can operate under the harsh/abnormal environment including wet (sea/fresh/brine water), hot/cold temperature conditions; chemically or radiologically- or biologically-tainted or compromised environment; excessive dust/dirt (including desert-type), wind, pressure and vibration environments.

The present application is related to the subject matter of co-pending U.S. Provisional Patent Applications Ser. No. 60/559,933 filed Apr. 6, 2004, Ser. No. 60/559,804 filed Apr. 6, 2004, and Ser. No. 60/559,805 filed Apr. 6, 2004, and to the non-provisional applications claiming the benefit thereof. All of these applications are incorporated herein by reference.

Although other modifications and changes may be suggested by those skilled in the art, it is the intention of the inventors to embody within the patent warranted hereon all changes and modifications as reasonably and properly come within the scope of their contribution to the art.

1. A portable identity authentication apparatus, comprising:
a housing;
first and second imaging devices mounted in said housing, said first and second imaging devices being directed to a common point so as to image a subject in a stereographic manner;
a processor in said housing connected to receive image data from said first and second imaging devices; and
processing software operable on said processor so as to generate two dimensional and three dimensional biometric information on a person to be identified.

2. A portable identity authentication apparatus as claimed in claim 1, further comprising:
visible light and infrared light emitters mounted on said housing and directed toward the common point to which said first and second imaging devices are directed.

3. A method for authenticating an identity of a person to be identified, comprising the steps of:
obtaining a stereographic image of the person to be identified;
processing said stereographic image to generate two dimensional and three dimensional biometric data of the person to be identified;
comparing said two dimensional and three dimensional biometric data of the person to be identified to two dimensional and three dimensional biometric data of an identified person so that upon agreement of said biometric data an identity of the person is authenticated.
